(19) United States
(12) Patent Application Publication
(10) Pub. No.: US 2004/0190997 A1
(43) Pub. Date: Sep. 30, 2004

(54) Thrust block form apparatus and system

(76) Inventor: Daniel F. Farrier, Georgetown, TX (US)

Correspondence Address: THOMPSON & KNIGHT L.L.P., PATENT PROSECUTION DEPARTMENT, 98 SAN JACINTO BLVD., SUITE 1900, AUSTIN, TX, 78701, US

(21) Appl. No.: 10/403,701

(22) Filed: Mar. 31, 2003

(51) Int. Cl. F16L 1/06

(52) U.S. Cl. 405/184.4

(57) ABSTRACT

The present invention provides a thrust block form for use with underground pipelines and piping systems. An inexpensive, disposable or reusable sheet of material that includes lines, indentations, or perforations to facilitate field folding, and that may have wings, or connect to wings, is used to quickly and accurately determine and define a necessary shape and configuration of a thrust block for a selected fitting. A thrust block form is adapted to conform with all fittings of a selected size, and a table printed on the sheet of material provides quick reference for accuracy and time savings.

### BACKGROUND OF THE INVENTION

1. Field of the Invention

The present invention relates generally to the construction of thrust blocks for use with fluid piping systems. More particularly, the present invention relates to an apparatus and system for forming a thrust block for use with fittings in pressurized underground fluid pipelines.

2. Description of Related Art

Thrust blocks are commonly used in construction to support large forces. In pressurized piping networks, such as those found in municipal water, irrigation, and waste piping systems, thrust blocks are commonly used to prevent pipeline fittings from moving, yet allow the pipe to move or flex within the joint in response to variation in temperature or slight ground movement. Thrust blocks are used in certain piping systems at all points of direction change, points of size change, and points of termination.

When forming a thrust block in a piping system, the union of a thrust block to a pipeline fitting should meet three criteria:

The thrust block must provide sufficient bearing surface area on the outer shape of the pipeline fitting, as determined by the strength of the pipe fitting, and should not include any portion of the bell gasket housing;

The thrust block should not create concentrated loads or friction wear on the fitting during normal flexing movement of the pipeline; and

The thrust block should not interfere with the flexing motion between the pipe and the fitting.

The size of a thrust block is defined by the cross-sectional surface area against undisturbed soil. The minimum required size is based upon four parameters:

Bearing strength of the soil—the ability for the undisturbed soil to resist movement. Bearing strength is typically measured in lbs/ft² (psf). Bearing loads may be as low as 0 psf for muck, peat, etc. and may reach 10,000 psf for hard shale.

Internal pressure of the piping system—the forces that a thrust block must resist are directly proportional to the internal pipeline pressure. Pipeline pressure is usually measured in psi.

Size of the piping system—the internal pipeline pressure (psi) acts on the cross sectional of the pipeline fitting (in²) to create a thrust force (pounds) on the pipeline fitting.

Configuration of the fitting—tee fittings, bends, crosses, offsets, valves, and ends are common fittings, and each fitting is associated with forces exerted on the pipeline. Force vectors and their resulting sum, determine the magnitude and direction of the resultant fitting thrust force.

Through common engineering calculations or tables, one can obtain the aggregate minimum surface area required based on the four parameters of soil bearing strength, maximum internal pressure, fitting configuration, and fitting size.

Creating a standardized and adjustable form mold for creating a thrust block is hindered by unique measurements and shapes between the pipeline fitting and the undisturbed trench wall that must be used to resist the fitting thrust forces. The undisturbed trench wall of each thrust block site has a unique shape. The dimensions between the fitting and the undisturbed trench wall are also unique for each excavation site. Custom fabrication of forms for containing the concrete pour forming the thrust block is expensive in labor and materials.

It is not uncommon for thrust blocks to be poured without fabricated forms. The result is excessive and uncontained concrete. The ability for an inspector to determine if the thrust block meets the minimum required surface area is diminished. The resulting thrust block is without dimensional control or measurement. Excessive concrete use is normal to insure thrust force restraint. In addition to excessive concrete to insure adequate thrust restraint, a significant amount of uncontained concrete forms in areas and places that do not contribute to the resistance of thrust forces.

Further, if concrete forms over the bell gasket housing or ring-type seal joints, the usefulness and intended design flexibility of the joint is reduced or eliminated. Lastly, excessive use of concrete can result in the inadvertent burial of cables or other items sharing a trench with the pipeline.

It is therefore desirable to provide a means to construct a thrust block for use with underground pipeline fittings. It is further desirable to provide a means for determining the correct minimum size of a thrust block for a specific application. It is therefore desirable to reduce the time necessary to determine the correct size of a thrust block

It is also desirable to provide a means to adjust and adapt a form for constructing a thrust block to the unique measurements and shapes between the pipeline fitting and the undisturbed earth of the trench wall.

It is also desirable to provide a means for constructing a thrust block that is less expensive than custom manufacturing each thrust block form. It is further desirable to provide a means for reducing the material and labor necessary to construct a thrust block form.

It is further desirable to provide a means for controlling the amount and placement of concrete that is needed to construct a thrust block used with underground pipelines and piping systems. It is therefore desirable to provide a means for controlling and constraining concrete poured around pipeline fittings in a trench.

### BRIEF SUMMARY OF THE INVENTION

The present invention provides means to adapt, indicate, and establish a size of a thrust block for use in pressurized piping systems.

In one broad respect, the present invention is directed to a thrust block form able to adapt a measurable thrust block form to the unique and variable nature of the area between the pipeline fitting placement and the undisturbed trench wall.

In one broad respect, the present invention is directed to a thrust block form able to conform to a fitting and adapted for use with fittings of various configurations within a given nominal size. Some common configurations of pipe fittings that can be accommodated include tee fittings, 90° bend fittings, 45° bend fittings, 22.5° bend fittings, 11.25° bend fittings, and end fittings.

The preferred embodiment of the invention is a pour-in-place form that is disposable and left in place. The invention comprises an inexpensive, semi-rigid material. In some embodiments, the invention is constructed of cardboard.

The device includes a semi-rigid sheet having an aperture. The semi-rigid sheet is foldable into a mold form between the pipeline fitting and the undisturbed earthen trench wall. The aperture is edged by a deformable lip for closely conforming to the outer shape of the body of the pipeline fitting. The lip may be notched.

In a more preferred embodiment of the present invention, the device also includes semi-rigid wing members, wherein the semi-rigid wing members are adjustable and can be rotated about a fold line. The semi-rigid wing members can be separate and attachable to the foldable, semi-rigid sheet or can be an integral part, or of a permanent connection of the semi-rigid sheet. The semi-rigid wing members may be composed of any suitable material, examples of which are cardboard or plastic.

The semi-rigid wing members may be characterized by a substantially uniform height. Further, the semi-rigid wing members may be flexibly spread apart at an adequate wingspan determined by reference to a specific application-determined wingspan table according to uniform wingspan height, pipeline fitting size, pipeline system pressure, soil bearing strength, and the configuration of the of the pipeline fitting.

A system for forming a thrust block used to support a pipeline fitting would also be within the scope of the claimed invention. The system would essentially include a semi-rigid sheet having an aperture closely conforming to the outer shape of the pipeline fitting of a variety of pipeline fitting configurations; and semi-rigid wing members adapted for hinged folding for dimensional control of the thrust block surface area to be created by the molding form. The semi-rigid sheet and the semi-rigid wings in combination are further capable to define a thrust block having a selected wingspan based on the characteristics of the wing member uniform height, pipeline fitting size, pipeline fitting configuration, piping system pressure, and soil bearing strength.

Another embodiment of the present invention essentially is a device for forming a thrust block for use with an underground pipeline system. The device includes a form having an aperture. The aperture is shaped to surround a portion of a pipe fitting, and the form is suitable for molding at least a portion of the thrust block. In several embodiments, the device accommodates pipe fittings selected from the group consisting of tee fittings, 90° elbow fittings, 45° elbow fittings, 22.5° elbow fittings, 11.25° elbow fittings, and end fittings.

### BRIEF DESCRIPTION OF THE DRAWINGS

The following drawings form part of the present specification and are included to further demonstrate certain aspects of the present invention. The figures are not necessarily drawn to scale. The invention may be better understood by reference to one or more of these drawings in combination with the detailed description of specific embodiments presented herein.

FIG. 1 is an isometric view of a thrust block form in accordance with one embodiment of the present invention.

FIG. 2 shows a semi-rigid sheet configurable into a thrust block form with wings in accordance with one embodiment of the present invention.

FIG. 3 shows a semi-rigid sheet configurable into a thrust block form with attachable wing members in accordance with another embodiment of the present invention.

FIG. 4 is an isometric view of a configuration of a thrust block form with its aperture closely conforming to the outer shape of a pipeline fitting in accordance with one embodiment of the present invention.

FIGS. 5A, 5B, 5C, and 5D are top views of a thrust block form with wing members rotated about a hinged fold line adjusted to various wingspans as appropriate in accordance with one embodiment of the present invention.

FIGS. 6A, 6B, 6C, 6D, 6E, and 6F show uses of thrust block forms with various pipeline fitting configurations in accordance with embodiments of the present invention.

FIG. 7 is perspective view from the back of a configured thrust block form indicating a resultant substantially rectangular cross-sectional surface area that provides the functional surface area against the undisturbed earthen trench wall to resist thrust forces and to prevent pipeline fitting movement.

### DETAILED DESCRIPTION OF PREFERRED EMBODIMENTS

The following examples are included to demonstrate embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

The present invention addresses and overcomes the lack of availability of existing forms or methods of the construction of forms for the purpose of molding thrust blocks, with a standardized, measurable, and inexpensive apparatus and system for the forming and construction of thrust blocks.

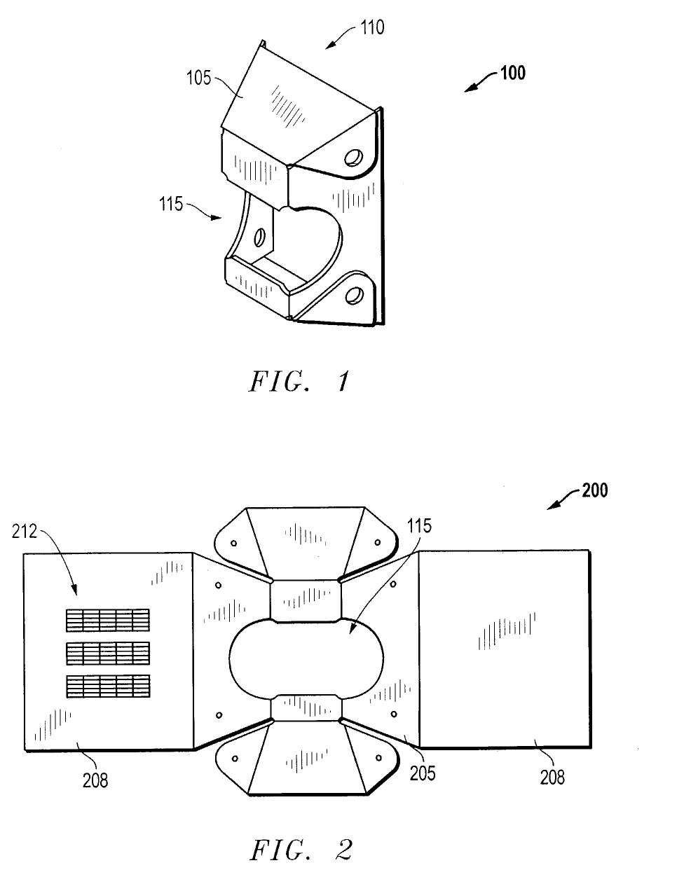

FIG. 1 is an isometric view of a thrust block form 100. In the embodiment shown in FIG. 1, the thrust block form 100 comprises a semi-rigid sheet of material 105 that has been configured into a form 110 for molding a thrust block, with an aperture 115 adapted for accommodating a pipeline fitting. In some embodiments, the sheet of material 105 may be cardboard or other semi-rigid materials.

The semi-rigid sheet of material 105 may comprise one or more patterns of lines, pre-stressed fold lines or perforations to facilitate configuration into one or more forms.

The aperture 115 is adapted to conform to pipeline fittings of various configurations within a given nominal size. An appropriately sized aperture 115 will ideally be large enough to provide sufficient bearing surface area on the fitting, yet small enough to prevent concrete from contacting any portion of the bell gasket housing or the joint between the fitting and the pipeline. In some embodiments, the aperture 115 has a deformable lip to contact and conform to the pipeline fitting.

Now referring to FIG. 2, a thrust block form 200 in accordance with one embodiment of the present invention comprises a semi-rigid sheet of material 205 that is configurable into a molding form, including an aperture 115, and further includes wing members 208, defining a form for molding a thrust block.

In the preferred embodiment, the sheet of material 205 further includes a table 212 indicating the required wingspan width for adjusting the functional size (thrust resistant surface area) of the form after the form is placed on the pipeline fitting thus the implementation that facilitates constructing the form quickly and accurately.

The following TABLE 1 provides one example of a table 212 that would be used in the preferred embodiment with a thrust block form 200 suitable for use with 4″ pipeline fittings.

TABLE 1

| | | | | |
|---|---|---|---|---|
| Pressure | 90° Bend | Tee/DE | 45° Bend | 22 ½° Bend |

1,000 lb/ft² Soil Bearing Capacity

| | | | | |
|---|---|---|---|---|
| 100 psi | 20.5″ | 14.5″ | 11.1″ | 5.7″ |
| 125 psi | 25.6″ | 18.2″ | 13.9″ | 7.1″ |
| 150 psi | *30.8″ | 21.8″ | 16.7″ | 8.5″ |
| 200 psi | *41.0″ | *29.0″ | 22.2″ | 11.4″ |
| 250 psi | *51.2″ | *36.2″ | *27.8″ | 14.2″ |

2,000 lb/ft² Soil Bearing Capacity

| | | | | |
|---|---|---|---|---|
| 100 psi | 10.3″ | 7.3″ | 5.6″ | 2.9″ |
| 125 psi | 12.8″ | 9.1″ | 7.0″ | 3.6″ |
| 150 psi | 15.4″ | 10.9″ | 8.4″ | 4.3″ |
| 200 psi | 20.5″ | 14.5″ | 11.1″ | 5.7″ |
| 250 psi | 25.6″ | 18.2″ | 13.9″ | 7.1″ |

3,000 lb/ft² Soil Bearing Capacity

| | | | | |
|---|---|---|---|---|
| 100 psi | 6.9″ | 4.9″ | 3.7″ | 1.9″ |
| 125 psi | 8.6″ | 6.1″ | 4.7″ | 2.4″ |
| 150 psi | 10.3″ | 7.3″ | 5.6″ | 2.9″ |
| 200 psi | 13.7″ | 9.7″ | 7.4″ | 3.8″ |
| 250 psi | 17.1″ | 12.1″ | 9.3″ | 4.8″ |

*designates that an expansion wing is required

The following TABLE 2 is a second example of a table 212 that would be used in the preferred embodiment with a thrust block form 200 suitable for use with 2″ pipeline fittings.

TABLE 2

| | | | | |
|---|---|---|---|---|
| Pressure | 90° Bend | Tee/DE | 45° Bend | 22 ½° Bend |

1,000 lb/ft² Soil Bearing Capacity

| | | | | |
|---|---|---|---|---|
| 100 psi | 10.1″ | 7.1″ | 5.5″ | 2.8″ |
| 125 psi | 12.6″ | 8.9″ | 6.8″ | 3.5″ |
| 150 psi | 15.1″ | 10.7″ | 8.2″ | 4.2″ |
| 200 psi | 20.1″ | 14.2″ | 10.9″ | 5.6″ |
| 250 psi | 25.1″ | 17.8″ | 13.6″ | 7.0″ |

2,000 lb/ft² Soil Bearing Capacity

| | | | | |
|---|---|---|---|---|
| 100 psi | 5.1″ | 3.6″ | 2.8″ | 1.4″ |
| 125 psi | 6.3″ | 4.5″ | 3.4″ | 1.8″ |
| 150 psi | 7.6″ | 5.4″ | 4.1″ | 2.1″ |
| 200 psi | 10.1″ | 7.1″ | 5.5″ | 2.8″ |
| 250 psi | 12.6″ | 8.9″ | 6.8″ | 3.5″ |

3,000 lb/ft² Soil Bearing Capacity

| | | | | |
|---|---|---|---|---|
| 100 psi | 3.4″ | 2.4″ | 1.9″ | 1.0″ |
| 125 psi | 4.2″ | 3.0″ | 2.3″ | 1.2″ |
| 150 psi | 5.1″ | 3.6″ | 2.8″ | 1.4″ |
| 200 psi | 6.7″ | 4.8″ | 3.7″ | 1.9″ |
| 250 psi | 8.4″ | 6.0″ | 4.6″ | 2.4″ |

Now referring to FIG. 3, an embodiment of the present invention is shown in which a thrust block form 300 comprises a sheet 301 that is configurable for defining a thrust block form, with two separate and attachable side wing members 306, singularly or in combination with the side wing members 306 defining the trust block form 300. Similar to the sheet of material 205 shown in FIG. 2, the sheet of material 305 may include information in the form of a table 315, to facilitate construction in the field accurately and quickly. The information contained in the table is application specific to the nominal size of the fitting for which the thrust block form is designed.

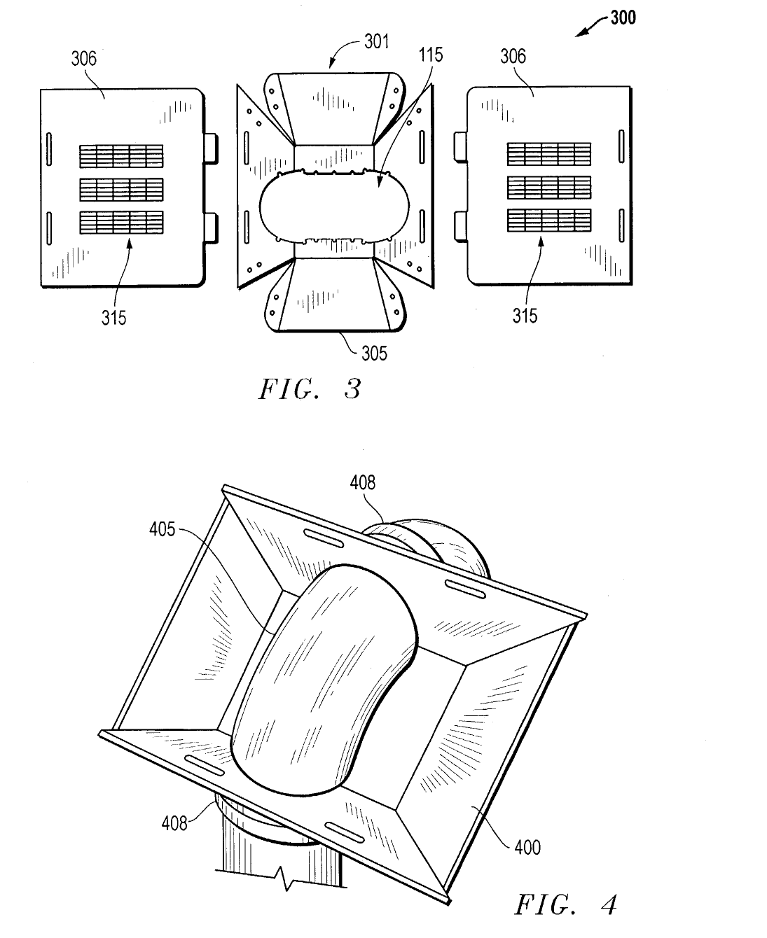

Now referring to FIG. 4, an embodiment of the present invention is shown as it may be used to support a bend fitting 405 in a pipeline. In the embodiment shown the fitting 405 is a 90° bend fitting. However, the invention is not limited to use with any one fitting, but is adapted for use and usable on one of several fittings with a nominal fitting size.

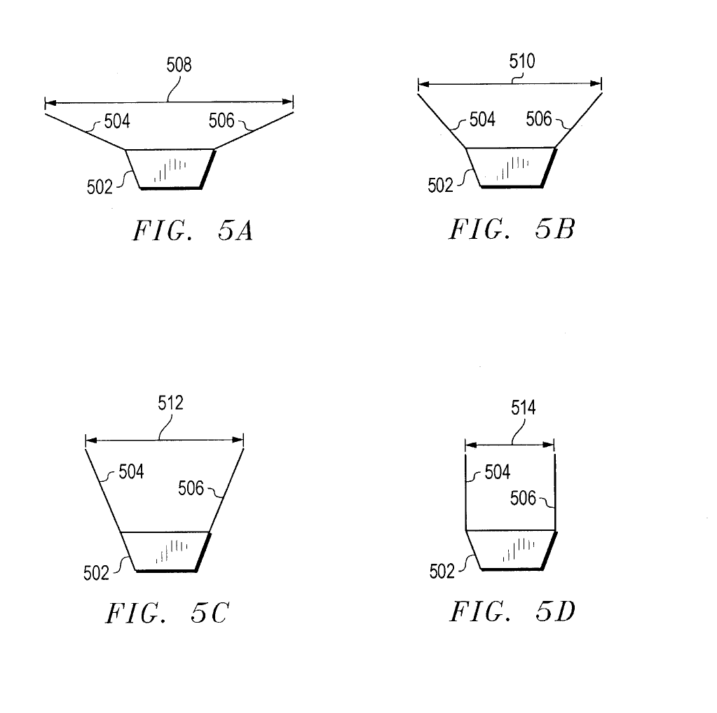

FIGS. 5A, 5B, 5C, and 5D show a thrust block form 502 having hingedly connected wings 504, 506 adjusted to various wingspans 508, 510, 512, and 514. Further, the combination of wingspan with the uniform vertical height of the wing members of the form creates a measurable and determined cross-sectional surface area defining the total thrust resistance surface area of the thrust block being formed.

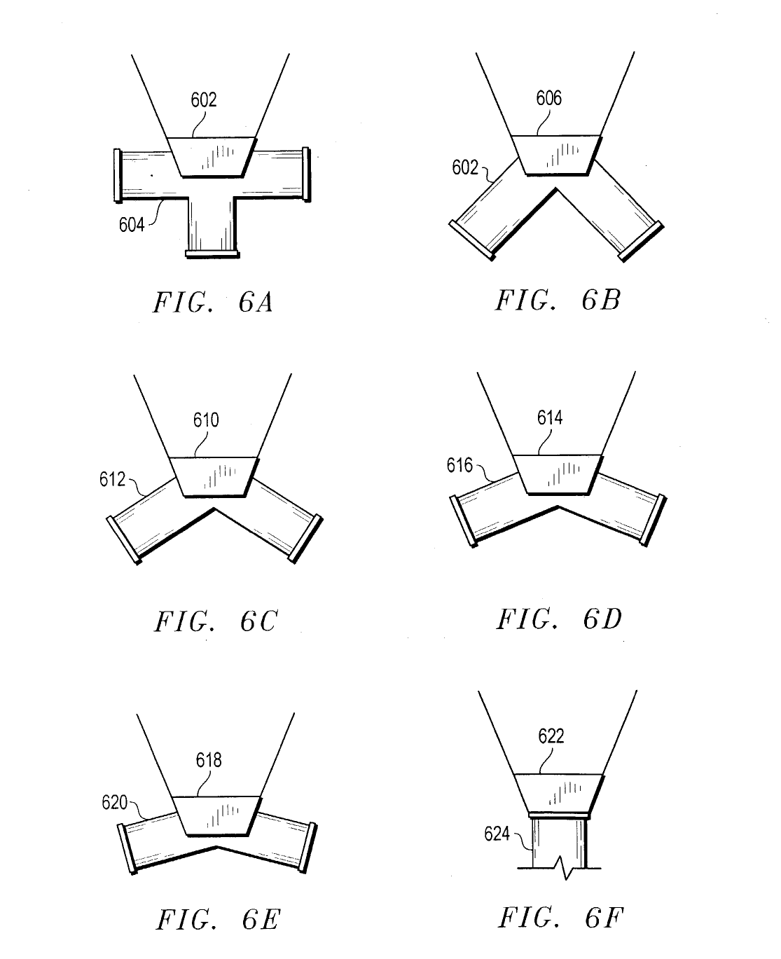

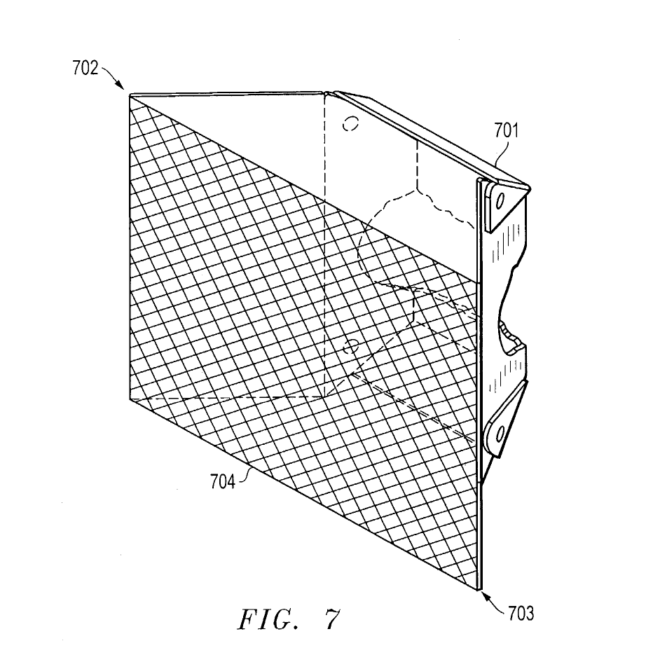

Turning to FIGS. 6A, 6B, 6C, 6D, 6E, and 6F, the applications of various thrust block forms 602, 606, 610, 614, 618, and 622 to various pipe fittings—tee fitting 604, 90° fitting 608, 45° fitting 612, 22.5° fitting 616, 11.25° fitting 620, and end fitting 624, respectively—are shown. The specific fittings shown, and their dimensions, have been selected merely by way of example, and not by way of limitation.

FIG. 7 shows an embodiment of the present invention wherein a folded thrust block form 701, is shown with the ability to create a determinate and substantially rectangular force resistance area 704 as defined by the outer edge of the wing member 702 and the outer and opposite edge of wing member 703.

In the preferred embodiment of the present invention, the wing members 702 and 703 are of substantially uniform height. The uniform height of wing members fixes or makes constant one of the dimensions defining the cross-sectional area of the thrust block being formed. The rotation of the wing members about the hinged fold line allows the 2^{nd} dimension of the substantially rectangular area to be set, adjusted, or determined by the distance between the outer and opposite edges of the wing members. The distance between the edges of the two outer and opposite edges of the wing members is denoted as the wingspan. With one dimension of the substantially rectangular thrust resistant cross-sectional surface area determined by the uniform height of the wing member, then the total cross-sectional area becomes directly proportional to the adjustable wingspan dimension. This dimensional relationship, as a result of the formation of a substantially rectangular cross-sectional area, eases creation of unique and specific adjustment tables 212 and 315 in the illustrated embodiments.

The present invention has been disclosed in connection with specific embodiments. However, it will be apparent to those skilled in the art that variations from the illustrated embodiments may be undertaken without departing from the spirit and scope of the present invention. For example, a sheet of material may have more than one aperture. This and other variations will be apparent to those skilled in the art in view of the above disclosure and are within the spirit and scope of the present invention. Further, the word “a” as used in this specification does not preclude the presence of a plurality of elements accomplishing the same function. The word “notched,” as used herein, includes the meaning of the word “varieted.”

All references cited herein are incorporated by reference to the maximum extent allowable by law. To the extent a reference may not be fully incorporated herein, it is incorporated by reference for background purposes and indicative of the knowledge of one of ordinary skill in the art.

What is claimed is:

1. A device for forming a mold for creating a thrust block for use with certain pressurized underground pipeline systems, the device comprising:
a semi-rigid sheet having an aperture;
wherein the semi-rigid sheet is foldable into a mold for at least a portion of the thrust block;
wherein the aperture is edged by a deformable lip for closely conforming to the outer shape of a portion of a pipeline fitting; and
wherein the aperture and the deformable lip are conformable to any of a variety configurations of pipeline fittings.

2. The device of claim 1, wherein the configurations of pipeline fittings are selected from the group consisting of tee fittings, 90° bend fittings, 45° bend fittings, 22.5° bend fittings, 11.25° bend fittings, and end fittings.

3. The device of claim 1, wherein the foldable, semi-rigid sheet is composed of cardboard.

4. The device of claim 1, wherein the foldable, semi-rigid sheet is composed of plastic.

5. The device of claim 1, wherein the deformable lip is notched.

6. The device of claim 1, wherein the aperture is characterized by a first curved end and a second curved end.

7. The device of claim 1, wherein the semi-rigid sheet is adapted to be foldable into a mold such that, when folded, the aperture is adapted to be closely conformable to the portion of the pipeline fitting and self-supports against the portion of the body of the pipeline fitting.

8. The device of claim 7, wherein the device is adapted to be foldable and placed on the pipeline fitting to form a mold with the body of the pipeline fitting at least partially inside the mold form and the bell ends of the pipeline fitting on the outside of the mold form.

9. The device of claim 7, further comprising:
at least two semi-rigid wing members, wherein at least one of the semi-rigid wing members is formed so as to be hingedly joined to a portion of the semi-rigid sheet.

10. The device of claim 9, wherein the at least two semi-rigid wing members are separate from and attachable to the remainder of the mold, thereby closely conforming to the outer shape of the pipeline fitting.

11. The device of claim 9, wherein the at least two semi-rigid wing members are composed of cardboard.

12. The device of claim 9, wherein the at least two semi-rigid wing members are composed of plastic.

13. The device of claim 9, wherein the at least two semi-rigid wing members are characterized by a substantially uniform height.

14. The device of claim 9, wherein the at least two semi-rigid wing members may be rotated on a vertical fold for adjustment of a wingspan between the outer most and opposite edges of the at least two semi-rigid wing members of the mold form.

15. The device of claim 14, wherein the wingspan between the outer and opposite edges of wing members is adjustable to an adequate wingspan that corresponds to a determined cross-sectional thrust block surface area as determined based on three factors of:
pipeline system pressure;
soil bearing strength; and
pipeline fitting configuration.

16. The device of claim 14, wherein each semi-rigid sheet includes a specific application-determined wingspan reference table for field reference in order to facilitate convenient determination of an adequate wingspan.

17. The device of claim 16, wherein the specific application-determined wingspan reference table is created base on five factors of:
wing member height;
pipeline fitting size;
soil bearing strength;
pipeline system pressure; and
pipeline fitting configuration.

18. A method for forming a thrust block for use with an underground pipeline system, the method comprising the steps of:
folding a semi-rigid sheet having an aperture, to form a mold for at least a portion of the thrust block, wherein the aperture is edged by a flexible lip closely conformable to any of a variety of type of pipe fittings;
positioning the mold onto a pipe fitting in the pipeline system such that the flexible, deformable lip closely conforms to a portion of the pipe fitting; and
spreading at least two semi-rigid wings hingedly joined at each of two opposite side edges of the semi-rigid sheet to an adequate wingspan determinable based on at least one factor selected from the group of pipeline system pressure, soil bearing strength, type of pipe fitting, and size of pipe fitting.

19. The method of claim 18 further comprising the step of:
pouring concrete into the mold.

20. A system for forming a thrust block used to support a pipe fitting in a pipeline, the system comprising:
a semi-rigid sheet having an aperture edged by a flexible lip closely conformable to a portion of any of a variety of type of pipe fittings; and
one or more semi-rigid wings adapted for hinged attachment to the semi-rigid sheet;
wherein the semi-rigid sheet and the one or more semi-rigid wings in combination are further capable to define a thrust block having a selected adequate wingspan based on one or more characteristics of the pipe fitting, piping system pressure, and soil bearing strength.

21. A device for forming a thrust block for use with an underground pipeline system, the device comprising:
a form having an aperture;
wherein the aperture is shaped to surround a portion of a pipe fitting; and
wherein the form is suitable for molding at least a portion of the thrust block.

22. The device of claim 21, wherein the type of pipe fitting is selected from the group consisting of tee fittings, 90° bend fittings, 45° bend fittings, 22.5° bend fittings, 11.25° bend fittings, and end fittings.

23. The device of claim 21, further comprising:
at least two wing members;
wherein one of the wing members is hingedly joined at each of two opposite side edges of the form; and
wherein the wing members are suitable for molding at least another portion of the thrust block.

24. The device of claim 21, wherein the edging of the aperture is adapted to closely conform to the surrounded portion of the pipe fitting.
